(19) United States
(12) Patent Application Publication
(10) Pub. No.: US 2026/0222050 A1
(43) Pub. Date: Jul. 30, 2026

(54) METHODS FOR ACTIVATION OF UNIFIED TCI STATES VIA MAC CE FOR MULTI-TRP SCHEMES

(71) Applicant: Telefonaktiebolaget LM Ericsson (publ), Stockholm (SE)

(72) Inventors: Siva Muruganathan, Stittsville, Ontario (CA); Claes Tidestav, Bålsta (SE); Helka-Liina Määttänen, Espoo (FI); Shiwei Gao, Nepean, Ontario (CA)

(21) Appl. No.: 19/144,633

(22) PCT Filed: Jan. 11, 2024
(86) PCT No.: PCT/IB2024/050310

§ 371 Date: Jun. 30, 2025

Related U.S. Application Data
(60) Provisional application No. 63/438,369, filed on Jan. 11, 2023.

(51) Int. Cl. H04B 7/06; H04W 72/231; H04W 76/20; H04W 80/02

(52) U.S. Cl. CPC H04B 7/06968; H04W 72/231; H04W 76/20; H04W 80/02

(57) ABSTRACT

Various embodiments provide for a method performed by a user equipment device and radio access network node for facilitating unified Transmission Configuration Indicator (TCI) states for multi Transmission Reception Point (TRP) use. The method includes receiving or providing Radio Resource Control (RRC) signaling to configure a single Downlink Control Information (DCI) multi-TRP scheme for a serving cell, wherein the RRC signaling comprises a Medium Access Control (MAC) Control Element (CE) message that comprises configuration information for downlink and/or uplink TCI states and their mapping to TCI codepoints. The method can then include activating one or more of the TCI states based on the MAC CE message.

### RELATED APPLICATIONS

This application claims the benefit of provisional patent application Ser. No. 63/438,369, filed Jan. 11, 2023, the disclosure of which is hereby incorporated herein by reference in its entirety.

### TECHNICAL FIELD

The present disclosure relates to methods and devices for activation of unified Transmission Configuration Indication (TCI) states via Medium Access Control (MAC) Control Element (CE) messages for multiple Transmission Reception Point (TRP) schemes in a wireless communication system.

### BACKGROUND

### New Radio (NR)

The new generation mobile wireless communication system (5G) or new radio (NR) supports a diverse set of use cases and a diverse set of deployment scenarios.

NR uses Cyclic Prefix Orthogonal Frequency Division Multiplexing (CP-OFDM) in the downlink (DL) (i.e., from a network node, gNB, eNB, or base station, to a user equipment (UE)) and both CP-OFDM and Discrete Fourier Transform-spread OFDM (DFT-S-OFDM) in the uplink (UL) (i.e., from UE to gNB). In the time domain, NR downlink and uplink physical resources are organized into equally-sized subframes of 1 ms each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespectively of the subcarrier spacing.

Typical data scheduling in NR are per slot basis, an example is shown in FIG. 1 where the first two symbols 104 and 106 of the slot 102 contain physical downlink control channel (PDCCH) and the remaining 12 symbols contains physical data channel (PDCH), either a PDSCH (physical downlink data channel) or PUSCH (physical uplink data channel).

Different subcarrier spacing values are supported in NR. The supported subcarrier spacing values (also referred to as different numerologies) are given by Δf=(15×2^{α}) kHz where α is a non-negative integer. Δf=15 kHz is the basic subcarrier spacing that is also used in LTE. The slot durations at different subcarrier spacings are shown in Table 1.

TABLE 1
Slot length at different numerologies.

| | | |
|---|---|---|
| | Slot | |
| Numerology | length | RB BW |

| | | | | | |
|---|---|---|---|---|---|
| 15 | kHz | 1 | ms | 180 | kHz |
| 30 | kHz | 0.5 | ms | 360 | kHz |
| 60 | kHz | 0.25 | ms | 720 | kHz |
| 120 | kHz | 125 | μs | 1.44 | MHz |
| 240 | kHz | 62.5 | μs | 2.88 | MHz |

In the frequency domain physical resource definition, a system bandwidth is divided into resource blocks (RBs), each corresponds to 12 contiguous subcarriers. The common RBs (CRB) are numbered starting with 0 from one end of the system bandwidth. The UE is configured with one or up to four bandwidth part (BWPs) which may be a subset of the RBs supported on a carrier. Hence, a BWP may start at a CRB larger than zero. All configured BWPs have a common reference, the CRB 0. Hence, a UE can be configured a narrow BWP (e.g., 10 MHz) and a wide BWP (e.g., 100 MHz), but only one BWP can be active for the UE at a given point in time. The physical RB (PRB) are numbered from 0 to N−1 within a BWP (but the 0:th PRB may thus be the K:th CRB where K>0).

The basic NR physical time-frequency resource grid 202 is illustrated in FIG. 2, where only one resource block (RB) 206 within a 14-symbol slot is shown. One OFDM subcarrier during one OFDM symbol interval forms one resource element (RE) 204.

Downlink transmissions can be dynamically scheduled, i.e., in each slot the gNB transmits downlink control information (DCI) over PDCCH about which UE data is to be transmitted to and which RBs in the current downlink slot the data is transmitted on. PDCCH is typically transmitted in the first one or two OFDM symbols in each slot in NR. The UE data are carried on PDSCH. A UE first detects and decodes PDCCH and the decoding is successfully, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### QCL and TCI States

A Transmission Configuration Indication (TCI) state contains Quasi Co-location (QCL) information between two antenna ports. Two antenna ports are said to be QCL if certain channel parameters associated with one of the two antenna ports can be inferred from the other antenna port. An antenna port is defined by a reference signal (RS). Therefore, a TCI state is used in NR to indicate the QCL relation between a source RS and a target RS. The source RS can be one of a NZP CSI-RS (Non-zero Power Channel State Information Reference Signal), tracking RS (TRS), and a SSB (Synchronization Signal Block), while the target RS can be a Demodulation Reference Signal (DMRS) for PDCCH or PDSCH, or a CSI-RS.

The supported QCL information types in NR include:

QCL-TypeA’: {Doppler shift, Doppler spread,
average delay, delay spread}
‘QCL-TypeB’: {Doppler shift, Doppler spread}
‘QCL-TypeC’: {Doppler shift, average delay}
‘QCL-TypeD’: {Spatial Rx parameter}

A list of TCI states can be RRC configured in a higher layer parameter PDSCH-Config information element (IE) (see 3gpp TS 38.331 section 6.3.2 for details), up to 8 TCI states from the list can be activated with a Medium Access Control Control Element (MAC CE). In NR Rel-15, one TCI state is activated by a MAC CE for each TCI codepoint of a TCI field in DCI, where up to 8 TCI codepoints can be supported (see 3gpp TS 38.321 section 6.1.3.14 for details). In NR Rel-16, up to two TCI states can be activated by a MAC CE for each TCI codepoint (see 3gpp TS38.321 section 6.1.3.24). For dynamically scheduled PDSCH, one of the TCI codepoints is indicated in the TCI field of the DCI (DCI format 1_1 or DCI format 1_2) scheduling the PDSCH for PDSCH reception. For example, if a SSB or CSI-RS is configured as the QCL-typeD source RS in an activated TCI state indicated to a PDSCH, the same receive beam (or spatial filter) for receiving the SSB or CSI-RS would be used by a UE to receive the PDSCH.

For each CORESET, a list of TCI states can be RRC configured, one of the TCI states is activated by a MAC CE. For example, if a SSB is configured as the QCL-typeD source RS in an activated TCI state for a CORESET, the same receive beam for receiving the SSB can be used by a UE to receive PDCCHs transmitted in the CORESET.

Beam Management with Unified TCI Framework

In NR, downlink beam management is performed by conveying spatial QCL (‘Type D’) assumptions to the UE through TCI states.

Such a framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, with cause extra overhead and latency.

Furthermore, in majority of cases, the network transmits to and receive from a UE in the same direction for both data and control. Hence, using separate framework (TCI state respective spatial relations) for different channels/signals complicates the implementations.

In Rel-17, a unified TCI state based beam indicated framework was introduced to simplify beam management in FR2, in which a common beam represented by a TCI state may be activated/indicated to a UE and the common beam is applicable for multiple channels/signals such as PDCCH and PDSCH. The common beam framework is also referred to a unified TCI state framework. A TCI state configured under the newly introduced Rel-17 framework may henceforth be referred to as a unified TCI state.

A unified TCI state for separate TCI state operation or Joint TCI state operation comprises identifiers of two QCL source reference signals as shown below, where the first RS is a QCL source RS for one of {typeA, typeB, typeC} QCL types, while the second RS is a QCL source RS for QCL typeD. The second RS is used to indicate a spatial beam or filter associated with the unified TCI state. An example ASN.1 code for unified TCI state is shown below:

| DLorJoint-TCIState-r17 ::= | SEQUENCE { | |
|---|---|---|
| tci-StateUnifiedId-r17 | DLorJoint-TCIState-Id-r17, | |
| tci-StateType-r17 | ENUMERATED {DLOnly, JointULDL}, | |
| qcl-Type1-r17 | QCL-Info, | |
| qcl-Type2-r17 | QCL-Info | OPTIONAL -- Need R |

}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS- |

Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

A unified TCI state can be updated in a similar way as the TCI state update for PDSCH in Rel-15/16, i.e., with one of two alternatives:
Two-stage: RRC signaling is used to configure the number of unified TCI states in higher layer parameter PDSCH-config, and a MAC-CE is used to activate one of unified TCI states
Three-stage: RRC signaling is used to configure the number of unified TCI states in PDSCH-config, a MAC-CE is used to activate up to 8 unified TCI states, and a 3-bit TCI state bitfield in DCI is used to indicate one of the activate unified TCI states

The one activated or indicated unified TCI state will be used in subsequent PDCCH, PDSCH, and NZP CSI-RS transmissions until a new unified TCI state is activated or indicated.

The existing DCI formats 1_1 and 1_2 are reused for beam indication (i.e., TCI state indication/update), both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the UE reports an ACK.

For DCI-based beam indication the first slot to apply the indicated TCI is at least Y symbols after the last symbol of the acknowledgment of the joint or separate DL/UL beam indication. The Y symbols are configured by the gNB based on UE capability, which is also reported in units of symbols.

In release-17, a parameter unifiedTCI-StateType with values separate or joint is configured in IE ServingCellConfig in 3GPP TS 38.331 v17.2.0 with following field description:

unifiedTCI-StateType
Indicates the unified TCI state type the UE is configured for this serving cell. The value separate means this serving cell is configured with dl-OrJointTCI-StateList for DL TCI state and ul-TCI-ToAddModList for UL TCI state. The value joint means this serving cell is configured with dl-OrJointTCI-State List for joint TCI state for UL and DL operation. The network does not configure the field in a serving cell that is configured with more than one value for the coresetPoolIndex.

### Unified TCI States Activation/Deactivation MAC CE

In 3GPP TS 38.321 V17.2.0, a MAC CE 302 shown in FIG. 3 is specified for activating/deactivating unified TCI states. The MAC CE 302 has the following fields specified:
Serving Cell ID: This field indicates the identity of the Serving Cell for which the MAC CE 302 applies. The length of the field is 5 bits;
DL BWP ID: This field indicates a DL BWP for which the MAC CE 302 applies as the codepoint of the DCI bandwidth part indicator field as specified in 3GPP TS 38.212. The length of the BWP ID field is 2 bits;
UL BWP ID: This field indicates a UL BWP for which the MAC CE 302 applies as the codepoint of the DCI bandwidth part indicator field as specified in 3GPP TS 38.212 [9]. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in 3GPP TS 38.331. If D/U is set to 1, 7-bits length TCI state ID i.e. TCI-StateId as specified in 3GPP TS 38.331 is used. If D/U is set to 0, the most significant bit of TCI state ID is considered as the reserved bit and remainder 6 bits indicate the UL-TCIState-Id as specified in 3GPP TS 38.331. The maximum number of activated TCI states is 16;
R: Reserved bit, set to 0.

### Multi-TRP Schemes

In NR Rel-17, PDCCH repetition was introduced for more robust PDCCH reception in which a PDCCH is transmitted over two transmission and reception points (TRPs) on different time or frequency resources.

An example is shown in FIG. 4, where a PDCCH is repeated over two TRPs 402 and 404 at different times. The 1st PDCCH repetition is sent in a PDCCH candidate in CORESET #c1 associated with SS set #s1 to UE 406 and the second PDCCH repetition is sent in another PDCCH candidate in CORESET #c2 associated with SS set #s2, where SS sets #s1 and #s2 are linked.

Two linked SS sets need to be configured with a same set of parameters such as periodicity, slot offset, number of monitoring occasions within a slot, etc. For a given CCE aggregation level and two linked SS sets, the location of one PDCCH candidate in one SS set can be obtained from a PDCCH candidate in the other SS set. When performing PDCCH detection, the UE 406 may detect PDCCH individually in each PDCCH candidate or jointly by soft combining of the two PDCCH candidates.

### SFN PDCCH Scheme

In NR Rel-17, single frequency network (SFN) based PDCCH was also introduced for more robust PDCCH reception in which a PDCCH is transmitted simultaneously from two TRPs in a same time and frequency resource. An example is shown in FIG. 5, where a single CORESET and the associated SS set are associated to both TRPs 402 and 404.

Multi-TRP (mTRP) PDSCH Schemes

In NR Rel-16, PDSCH transmission over two TRPs was introduced, including a non-coherent joint transmission (NC-JT) scheme, two frequency domain multiplexing (FDM) schemes, and two time domain multiplexing (TDM) schemes. In these multi-TRP PDSCH schemes, each TRP is represented by an indicated TCI state. In NC-JT, a PDSCH in transmitted over two TRPs in a same time and frequency resource with different MIMO layers of the PDSCH transmitted from different TRPs. For example, 2 layers can be transmitted from a first TRP and 1 layer can be transmitted from a second TRP for a total of 3 layers. For NC-JT based PDSCH scheduling, two TCI states are indicated in a TCI codepoint of DCI scheduling the PDSCH. The DMRS ports in a first and second CDM groups are associated with the first and second TCI states, respectively.

In the FDM schemes, different frequency domain resources of a PDSCH are allocated to different TRPs. In FDM scheme A, a single PDSCH is transmitted and part of the PDSCH is sent from one TRP and the rest from the other TRP. In FDM scheme B, a PDSCH is repeated over two TRPs. For FDM based multi-TRP PDSCH scheduling, two TCI states are indicated in a TCI codepoint of DCI scheduling the PDSCH. The DMRS ports in a first and second set of scheduled RBs are associated with the first and second TCI states, respectively.

In the TDM schemes, a PDSCH is repeated in multiple times, each over one of two TRPs. In TDM scheme A, a PDSCH is repeated two times within a slot, one from each TRP. While in TDM scheme B (or slot-based TDM scheme), a PDSCH is repeated in consecutive slots, either in a cyclic manner from two TRPs in which the PDSCH is transmitted alternatively from a first TRP in one slot and a second TRP in the next slot, or in a sequential manner in which PDSCH is transmitted alternatively from the first and second TRPs every two consecutive slots. For TDM based multi-TRP PDSCH scheduling, two TCI states are indicated in a TCI codepoint of DCI scheduling the PDSCH. The DMRS ports in a first and second set of PDSCH transmission occasions are associated with the first and second TCI states, respectively. The first and second set of PDSCH transmission occasions are determined according to the mapping type, i.e., cyclic or sequential mapping.

An example of TDM Scheme B is shown in FIG. 6, where 4 PDSCH repetitions are scheduled from two TRPs 402 and 406. In case of cyclic mapping 602, the 1^{st} and 3^{rd} PDSCH occasions are associated with the 1^{st} TCI state and the 2^{nd} and 4^{th} PDSCH occasions are associated with the 2^{nd} TCI state indicated in the DCI. In case of sequential mapping 604, the 1^{st} and 2^{nd} PDSCH occasions are associated with the 1^{st} TCI state and the 3^{rd} and 4^{th} PDSCH occasions are associated with the 2^{nd} TCI state indicated in the DCI.

### UL Transmission to Multiple Transmission Points (TRPs)

PDSCH transmission with multiple transmission points has been introduced in 3GPP for NR Rel-16, in which a transport block may be transmitted over multiple TRPs to improve transmission reliability.

In NR Rel-17, it has been agreed to introduce UL enhancement with multiple TRPs where a UE 406 transmits a PUCCH or PUSCH towards to different TRPs 402 and 404 as shown in FIG. 7, in different times (either in different slots or in different sets of symbols within a slot, also known sometimes referred to as subslot or mini-slot).

In one scenario, multiple PUCCH/PUSCH transmissions each towards a different TRP may be scheduled by a single DCI. For example, multiple spatial relations (i.e., spatial beams) may be activated for a PUCCH resource and the PUCCH resource may be signaled in a DCI scheduling a PDSCH. The HARQ A/N associated with the PDSCH is then carried by the PUCCH which is then repeated multiple times either within a slot or over multiple slots, each repetition is towards a different TRP. An example is shown in FIG. 8, where a PDSCH is scheduled by a DCI and the corresponding HARQ A/N is sent in a PUCCH which is repeated twice in time, one towards TRP #1 and the other towards TRP #2. Each TRP is associated with a PUCCH spatial relation.

An example of PUSCH repetitions is shown in FIG. 9, where two PUSCH repetitions for a same TB are scheduled by a single DCI, each PUSCH occasion is transmitted towards a different TRP. Each TRP is associated with an SRI signaled in DCI. Note that the spatial Transmit filter used to transmit PUSCH repetitions towards a given TRP are provided by the corresponding SRI.

There currently exist certain challenge(s). Although unified TCI states are specified in Rel-17, the unified TCI states are only applicable to single TRP schemes in NR Rel-17. The unified TCI framework is not applicable to multi-TRP schemes in NR Rel-17. In NR Rel-18, 3GPP is discussing applying unified TCI states to multi-TRP schemes.

However, the MAC CE of FIG. 3 specified in NR Rel-17 is not suitable for multi-TRP schemes as this MAC CE only allows a single DL/Joint TCI state or a single UL TCI state to be mapped to a TCI codepoint.

A MAC CE has been proposed for extending unified TCI states to multi-TRP schemes is proposed. However, it is assumed that the MAC CE activates at least one DL/joint TCI state and at least one UL TCI state. The MAC CE proposed is not suitable for joint TCI state operation where DL/Joint TCI state is applicable to both DL and UL in which case UL TCI states will not be configured separately for the UE. How to signal the activated unified TCI states for a MAC CE suitable for both joint TCI state operation and separate TCI state operation is an open problem that needs to be solved.

### SUMMARY

In an embodiment, a method performed by a user equipment (UE) is provided for facilitating unified Transmission Configuration Indicator (TCI) states for multi Transmission Reception Point (TRP) use. The method includes receiving from a Radio Access Network (RAN) node, signaling for a single Downlink Control Information, DCI, multi-TRP scheme for a serving cell, wherein the signaling comprises a Medium Access Control (MAC) Control Element, (CE) message that comprises a first field corresponding to the i^{th} TCI codepoint in the MAC CE message indicating whether the i^{th} TCI codepoint is mapped to at least one of a plurality of downlink, DL/joint TCI states, a second field corresponding to the i^{th} TCI codepoint in the MAC CE message indicating whether or not the i^{th} TCI codepoint is mapped to a second DL/joint TCI state. The method also includes activating a subset of DL/joint TCI states based on the MAC CE message and mapping one or more of the subset of DL/joint TCI states to one or more codepoints of the TCI field in the DCI.

In an embodiment, a presence of the second field is conditioned on the first field indicating that the i^{th} TCI codepoint is mapped to at least one of the plurality of DL/joint TCI states.

In an embodiment, a presence of an identifier field corresponding to the second of the plurality of DL/joint TCI states being mapped to the i^{th} TCI codepoint is conditioned on one or both of the following: the first field indicating that the i^{th} TCI codepoint is mapped to at least one of the plurality of DL/joint TCI states and the second field indicating that the i^{th} TCI codepoint is mapped to two of the plurality of DL/joint TCI states.

In an embodiment, the MAC CE message further comprises a third field corresponding to the i^{th} TCI codepoint in the MAC CE message indicates whether the i^{th} TCI codepoint is mapped to at least one UL TCI state of a plurality of UL TCI states or none of the plurality of UL TCI states.

In an embodiment, the MAC CE message further comprises a fourth field corresponding to the i^{th} TCI codepoint that indicates whether the i^{th} TCI codepoint is mapped to only one UL TCI state of the plurality of UL TCI states or two UL TCI states of the plurality of UL TCI states.

In an embodiment, a presence of the fourth field is conditioned on the third field indicating that the i^{th} TCI codepoint in the MAC CE message is mapped to at least one UL TCI state of the plurality of UL TCI states.

In an embodiment, for every i^{th} codepoint, a presence of one or more of the following TCI states is indicated a first DL or joint DL/UL TCI state; a second DL or joint DL/UL TCI state; a first UL TCI state; and a second UL TCI state.

In an embodiment, a Radio Resource Control (RRC) configuration indicates that the MAC CE message omits fields associated with UL TCI states based on an RRC parameter.

In an embodiment, a UE is provided for facilitating unified TCI states for single or multi-TRP use. The UE includes processing circuitry configured to receive from a RAN node, signaling to for a single DCI multi-TRP scheme for a serving cell, wherein the signaling comprises a MAC CE message that comprises a first field corresponding to the i^{th} TCI codepoint in the MAC CE message indicating whether the i^{th} TCI codepoint is mapped to at least one of a plurality of DL/joint TCI states, a second field corresponding to the i^{th} TCI codepoint in the MAC CE message indicating whether or not the i^{th} TCI codepoint is mapped to a second DL/joint TCI state. The processing circuitry also activates a subset of DL/joint TCI states based on the MAC CE message and mapping one or more of the subset of DL/joint TCI states to one or more codepoints of the TCI field in the DCI.

In an embodiment, a method performed by a RAN node is provided for facilitating facilitating unified TCI states for single or multi-TRP use. The method includes providing to a UE signaling for a single DCI multi-TRP scheme for a serving cell, wherein the signaling comprises a MAC CE message that comprises a first field corresponding to the i^{th} TCI codepoint in the MAC CE message indicating whether the i^{th} TCI codepoint is mapped to at least one of a plurality of downlink, DL/joint TCI states, a second field corresponding to the i^{th} TCI codepoint in the MAC CE message indicating whether or not the i^{th} TCI codepoint is mapped to a second DL/joint TCI state.

In an embodiment, a RAN node is provided for facilitating unified TCI states for single or multi-TRP use. The RAN node includes processing circuitry configured to provide to a UE signaling for a single DCI multi-TRP scheme for a serving cell, wherein the signaling comprises a MAC CE message that comprises a first field corresponding to the i^{th} TCI codepoint in the MAC CE message indicating whether the i^{th} TCI codepoint is mapped to at least one of a plurality of DL/joint TCI states, a second field corresponding to the i^{th} TCI codepoint in the MAC CE message indicating whether or not the i^{th} TCI codepoint is mapped to a second DL/joint TCI state.

In an embodiment, a method is provided that is performed by a UE for facilitating unified TCI states for multi-TRP use. The method includes receiving from a RAN node (1810), signaling for a single DCI, multi-TRP scheme for a serving cell, wherein the signaling comprises a MAC CE, message that comprises information indicating a first and/or second field indicating whether an i^{th} TCI codepoint is mapped to one or more downlink, DL/joint TCI state and a third and/or fourth field indicating whether the i^{th} TCI codepoint is mapped to one or more uplink, UL, TCI states. The method also includes activating a subset of DL/joint TCI states and UL TCI states based on the MAC CE message and mapping one or more of the activated subset of DL/joint TCI states and UL TCI states to one or more codepoints of the TCI field in the DCI.

In an embodiment, in the MAC CE message, for every i^{th} codepoint, a presence of one or more of the following TCI states is indicated a first DL or joint DL/UL TCI state; a second DL or joint DL/UL TCI state; a first UL TCI state; and a second UL TCI state.

In an embodiment, an RRC configuration indicates that the MAC CE message omits fields associated with UL TCI states based on an RRC parameter.

In an embodiment, a UE is provided for facilitating unified TCI states for multi-TRP use and includes processing circuitry configured to receiving from a RAN node, signaling for a single DCI, multi-TRP scheme for a serving cell, wherein the signaling comprises a MAC CE, message that comprises information indicating a first and/or second field indicating whether an i^{th} TCI codepoint is mapped to one or more downlink, DL/joint TCI state and a third and/or fourth field indicating whether the i^{th} TCI codepoint is mapped to one or more uplink, UL, TCI states. The processing circuitry also activates a subset of DL/joint TCI states and UL TCI states based on the MAC CE message and mapping one or more of the activated subset of DL/joint TCI states and UL TCI states to one or more codepoints of the TCI field in the DCI.

In an embodiment, a method is performed by a RAN node for facilitating unified TCI states for multi-TRP use and the method includes providing to a UE, signaling for a single DCI multi-TRP scheme for a serving cell, wherein the signaling comprises a MAC CE, message that comprises information indicating a first and/or second field indicating whether an i^{th} TCI codepoint is mapped to one or more downlink, DL/joint TCI state and a third and/or fourth field indicating whether the i^{th} TCI codepoint is mapped to one or more UL TCI states.

In another embodiment, a RAN node is provided for facilitating unified TCI states for multi-TRP use and the RAN node includes processing circuitry that provides to a UE, signaling for a single DCI multi-TRP scheme for a serving cell, wherein the signaling comprises a MAC CE, message that comprises information indicating a first and/or second field indicating whether an i^{th} TCI codepoint is mapped to one or more downlink, DL/joint TCI state and a third and/or fourth field indicating whether the i^{th} TCI codepoint is mapped to one or more UL TCI states.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of data scheduling in New Radio (NR) according to one or more aspects of the present disclosure;

FIG. 2 illustrates an example of a NR physical time-frequency resource grid according to one or more aspects of the present disclosure;

FIG. 3 illustrates a Medium Access Control (MAC) Control Element (CE) according to one or more aspects of the present disclosure;

FIG. 4 illustrates a Physical Downlink Control Channel (PDCCH) repetition according to one or more aspects of the present disclosure;

FIG. 5 illustrates a Single Frequency Network (SFN) based PDCCH according to one or more aspects of the present disclosure;

FIG. 6 illustrates time domain multiplexing (TDM) according to one or more aspects of the present disclosure;

FIG. 7 illustrates a multiple Transmission Reception Point (TRP) scheme according to one or more aspects of the present disclosure;

FIG. 8 illustrates a single Downlink Control Information (DCI) based multiple TRP scheme according to one or more aspects of the present disclosure;

FIG. 9 illustrates another single DCI based multiple TRP scheme according to one or more aspects of the present disclosure;

FIG. 10 illustrates another MAC CE according to one or more aspects of the present disclosure;

FIG. 11 illustrates another MAC CE according to one or more aspects of the present disclosure;

FIG. 12 illustrates a new MAC CE according to one or more aspects of the present disclosure;

FIG. 13 illustrates another new MAC CE according to one or more aspects of the present disclosure;

FIG. 14 illustrates a flowchart of a method for showing which MAC CE format to use depending on the number of configured lists of TCI states according to one or more aspects of the present disclosure;

FIG. 15 illustrates a flowchart of another method for showing which MAC CE format to use depending on the number of configured lists of TCI states according to one or more aspects of the present disclosure;

FIG. 16 illustrates a flowchart of a method performed by a UE for facilitating unified TCI states for single TRP or multi-TRP schemes according to one or more aspects of the present disclosure;

FIG. 17 illustrates a flowchart of a method performed by a RAN node for facilitating unified TCI states for single TRP or multi-TRP schemes;

FIG. 18 shows an example of a communication system 1800 in accordance with some embodiments;

FIG. 19 shows a UE 1900 in accordance with some embodiments;

FIG. 20 shows a network node 2000 in accordance with some embodiments;

FIG. 21 is a block diagram of a host according to some embodiments; and

FIG. 22 is a block diagram illustrating a virtualization environment according to some embodiments.

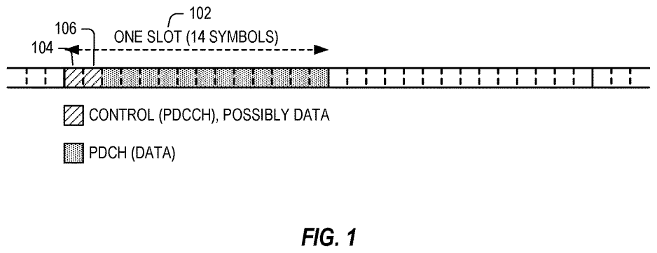

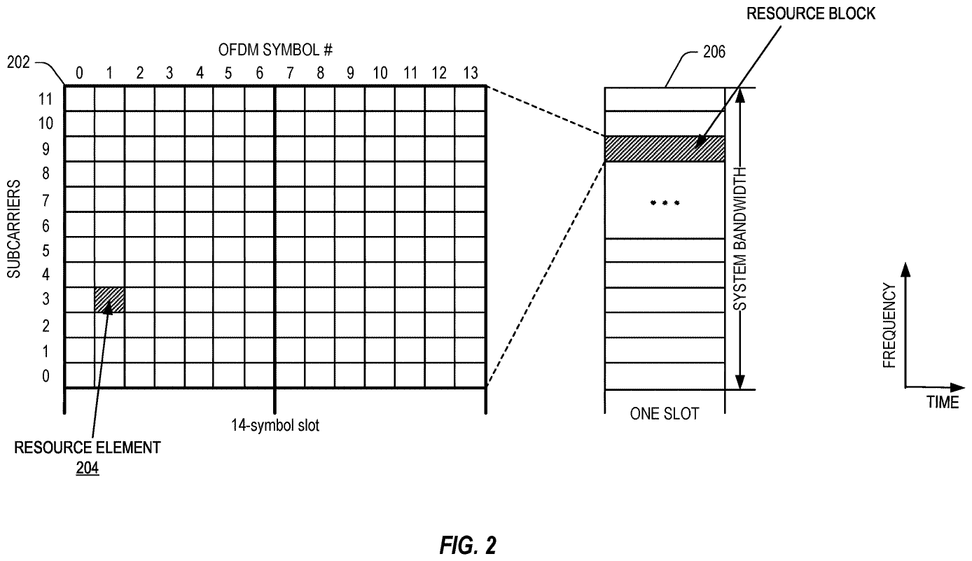

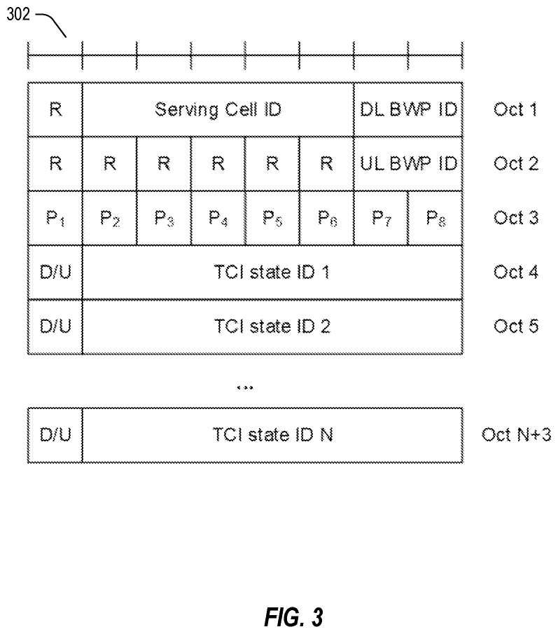

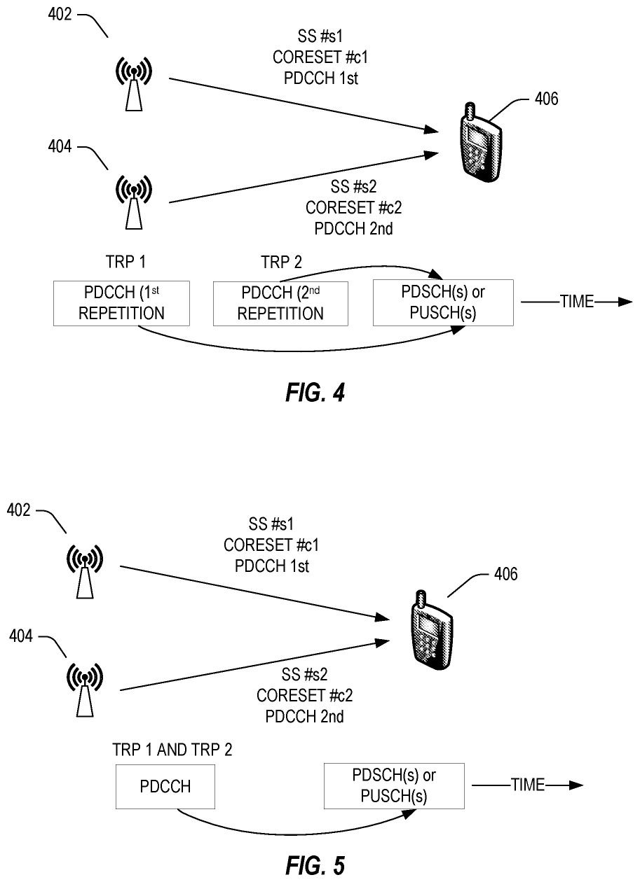

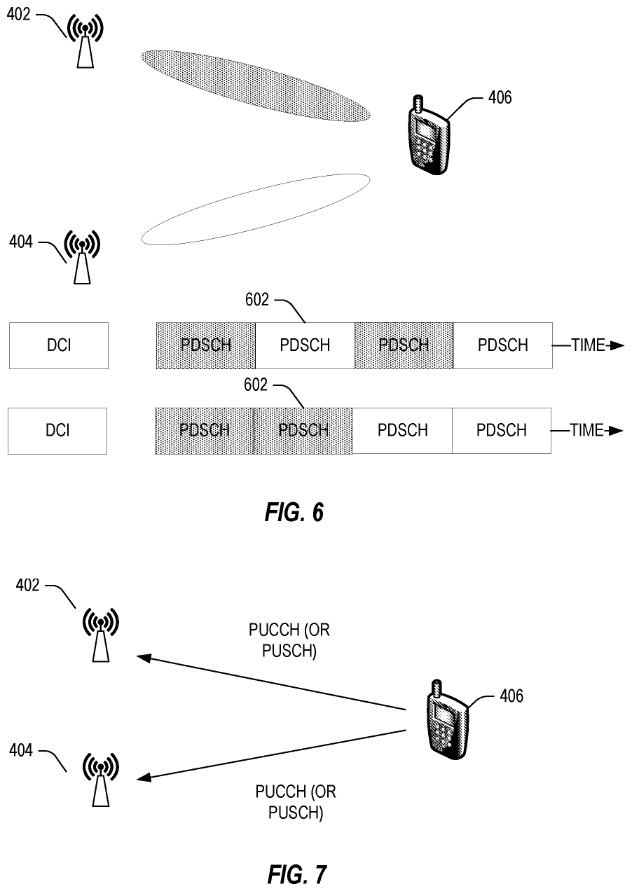

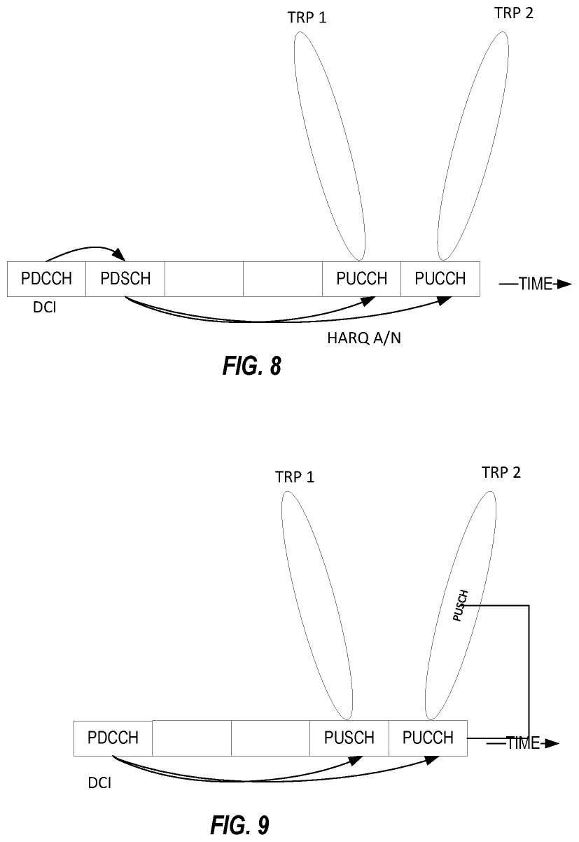

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Various embodiments provide for a method performed by a user equipment device and radio access network node for facilitating unified Transmission Configuration Indicator (TCI) states for multi Transmission Reception Point (TRP) use. The method include receiving or providing Radio Resource Control (RRC) signaling to configure a single Downlink Control Information (DCI) multi-TRP scheme for a serving cell, wherein the RRC signaling comprises a Medium Access Control (MAC) Control Element (CE) message that comprises configuration information for downlink (DL) and/or uplink (UL) TCI states and their mapping to TCI codepoints. The method can then include activating one or more of the TCI states based on the MAC CE message.

Certain aspects of the disclosure and their embodiments may provide solutions to these or other challenges. The present disclosure proposes MAC CE signaling suitable to activate/deactivate unified TCI states for multi-TRP schemes for both joint TCI state operation and separate TCI state operation. In some embodiments, the MAC CE format to use may depend on whether a serving cell is configured with only DL/Joint TCI state list(s) or with both DL/Joint TCI state list(s) and UL TCI state list(s).

Certain embodiments may provide one or more of the following technical advantage(s). The proposed solutions provide efficient MAC CE signaling mechanisms to support activation/deactivation of unified TCI states for multi-TRP schemes for both joint TCI state operation and separate TCI state operation. With the proposed solutions, the unified TCI framework can be efficiently extended to multi-TRP schemes.

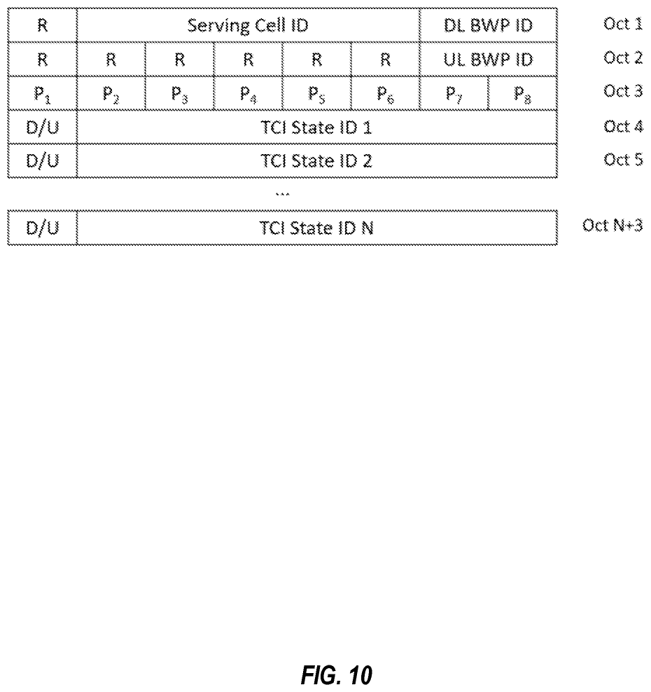

In a first embodiment (Embodiment 1) Fields in a legacy MAC CE can be reinterpreted when a single list of DL/Joint TCI states is configured in a serving cell. In one embodiment, when a list of DL/Joint TCI states is configured (i.e., either per DL Bandwidth Part (BWP) or per Physical Downlink Shared Channel (PDSCH) Config within a serving cell), and at least one of the single DCI based multi-TRP schemes (either for downlink or uplink) is configured or enabled in the serving cell, then the unified TCI states activation/deactivation MAC CE of clause 6.1.3.47 of 3GPP TS 38.321 V17.2.0 (shown in FIG. 10) is reused with reinterpretation of certain fields for activation of a subset of DL/joint TCI states in the list of DL/Joint TCI states. In some embodiments, a higher layer parameter (e.g., RRC parameter) may be configured to the User Equipment (UE) that is used to indicate to the UE that certain fields in the unified TCI states activation/deactivation MAC CE of clause 6.1.3.47 of 3GPP TS 38.321 V17.2.0 are reinterpreted as proposed in this embodiment. In one example, the parameter unifiedTCI-StateType-17 being set to ‘joint’, in combination with other higher layer parameters, may be used to indicate to the UE that certain fields in the unified TCI states activation/deactivation MAC CE of clause 6.1.3.47 of TS 38.321 needs to be reinterpreted. In another example, a new RRC parameter may be introduced for indicating this to the UE.

When single DCI based multi-TRP schemes are configured/enabled with unified TCI framework, the MAC CE should map each codepoint in a TCI field of a DCI (e.g., either DCI format 1-1 or 1-2) to either one or two of the activated DL/joint TCI states. Hence, the Pᵢ field in MAC CE of FIG. 10 is reinterpreted as follows:
If the Pᵢ field is set to 1, it indicates that the i^{th} TCI codepoint in the TCI field of the DCI is mapped to two of the activated DL/joint TCI states.
If the Pᵢ field is set to 0, it indicates that the i^{th} TCI codepoint in the TCI field of the DCI is mapped to one of the activated DL/joint TCI states.

As all TCI states indicated in the reinterpreted MAC CE are DL/joint TCI states, the ‘D/U’ fields are considered as reserved bits in the reinterpreted MAC CE. In an alternative the ‘D/U’ field is kept intact as it does not harm the operation either. In yet another alternative embodiment, it is stated that in the reinterpreted Mac CE, the ‘D/U’ field is always set to 0. In another alternative embodiment, in case the Pᵢ field is set to 0, and hence only one DL/Joint TCI state is mapped to the i^{th} TCI codepoint in the TCI field, the ‘D/U’ bit indicates if the TCI state corresponds to the first or second indicated TCI states, corresponding to the first or second TRP.

Note that in the legacy MAC CE of clause 6.1.3.47 of 3GPP TS 38.321, the Pᵢ field is interpreted differently from what is proposed in the embodiment above. In the legacy MAC CE, the Pᵢ field indicates if each codepoint is mapped to either 1 or 2 TCI states which includes the following possibilities:
If the Pᵢ field is set to 1, it indicates that the i^{th} TCI codepoint in the TCI field of the DCI is mapped to one activated DL TCI state and one UL TCI state.
If the Pᵢ field is set to 0, it indicates that the i^{th} TCI codepoint in the TCI field of the DCI is mapped to only one TCI state which can be either one activated DL TCI state or one activated UL TCI state.

Also, in legacy MAC CE of clause 6.1.3.47 of 3GPP TS 38.321, the D/U field in the same octet that carries the TCI state ID is needed to differentiate between a DL TCI state and an UL TCI state. On the contrary, in this embodiment, as all TCI states indicated in the reinterpreted MAC CE are DL/joint TCI states, the ‘D/U’ fields are considered as reserved bits in the reinterpreted MAC CE proposed in this embodiment. In an alternative embodiment, the ‘D/U’ field can be used to represent which TRP the single TCI state is associated with.

In one embodiment, the interpretation of the MAC CE is based on one or more RRC parameters. For example, the parameter unifiedTCI-StateType-17 being set to ‘joint’, and UE not being configured with Release 18 parameter(s) to enable UL or DL unified TCI state mTRP operation (or mode), UE follows the Release 17 interpretation of the MAC CE. If UE is configured with unifiedTCI-StateType-17 set to ‘joint’ and the UE is configured with Release 18 parameter(s) to enable UL or DL unified TCI state mTRP operation (or mode), then the UE follows the interpretation of the MAC CE as described in embodiment 1.

Although 2 activated DL/Joint TCI states are mapped to a single TCI field codepoint in the MAC CE proposed in this embodiment, this is non limiting and can be extended an integer T number of activated DL/Joint TCI states being mapped to a single TCI field codepoint. For instance, in this case, ┌ log₂(T)┐ number of bits are used in Pᵢ field to indicate how many activated DL/Joint TCI states are mapped to a single TCI field codepoint.

In a second embodiment (Embodiment 2) legacy MAC CE fields can be reinterpreted to enable joint or separate unified TCI state operation for single TRP or multi-TRP schemes.

In another embodiment, the unified TCI states activation/deactivation MAC CE of clause 6.1.3.47 of 3GPP TS 38.321 V17.2.0 (shown in FIG. 10) is reused with reinterpretation of certain fields for activation of a subset of DL/joint TCI states in the single list. In an alternative, this is defined in 3GPP specifications as a new MAC CE with new Logical Channel ID (LCID) or extended LCID (eLCID).

In this embodiment, one of the existing R fields is used to indicate whether the MAC CE is used for single TRP operation or mTRP operation. For example, the R field in the first octet is renamed as E field. If the E field has value ‘1’ the P field has mTRP interpretation and if E field has value ‘0’, the P field has the legacy interpretation.

The field description of the P field in the re-interpreted MAC CE in this embodiment would be revised as follows and field description for E field would need to be added as follows to the standard (the underlined section below is proposed amendments to clause 6.1.3.47 of 3GPP TS 38.321 V17.2.0)·
Pᵢ: This field indicates whether each TCI codepoint has multiple TCI states or single TCI state. If E field is set to 0 and Pᵢ field set to 1, it indicates that i^{th} TCI codepoint includes the DL TCI state and the UL TCI state. If E field is set to 0 and Pᵢ field set to 0, it indicates that i^{th} TCI codepoint includes only the DL TCI state or the UL TCI state; If E field is set to 1 and Pᵢ field set to 1, it indicates that i^{th} TCI codepoint includes two activated DL TCI states or two activated UL TCI states. If E field is set to 1 and Pᵢ field set to 0, it indicates that i^{th} TCI codepoint includes two the DL TCI state and two the UL TCI state;
E: This field indicate whether the MAC CE is for single TRP operation (joint or separate TCI state) or for single DCI mTRP operation (joint or separate TCI state));

In this embodiment UE is configured with RRC parameters describing whether the serving cell is configured with joint or separate TCI state operation. In an alternative, E field is replaced with additional RRC parameter describing whether UE is configured with single TRP operation, or with interpretation whether unifiedTCI-StateType-17 is present or not. If it is present UE is configured with single TRP operation. If a Release 18 parameter is present instead, UE is configured with single DCI based mTRP joint or separate unified TCI state operation.

In embodiment 3, there can be a new MAC CE when a list of DL/Joint TCI states and a list of UL TCI states are configured in a serving cell. In another embodiment, when a list of DL/Joint TCI states and a list of UL TCI states are configured and at least one of the single DCI based multi-TRP schemes (either for downlink or uplink) is configured or enabled in a serving cell, then a new MAC CE format is introduced to indicate one of the following mapping possibilities for the i^{th} TCI field codepoint in the TCI field of a DCI:
the i^{th} TCI codepoint in the TCI field of the DCI is mapped to one of the activated DL/joint TCI states
the i^{th} TCI codepoint in the TCI field of the DCI is mapped to two of the activated DL/joint TCI states
the i^{th} TCI codepoint in the TCI field of the DCI is mapped to one of the activated UL TCI states
the i^{th} TCI codepoint in the TCI field of the DCI is mapped to two of the activated UL TCI states
the i^{th} TCI codepoint in the TCI field of the DCI is mapped to one of the activated DL/joint TCI states and one of the activated UL TCI states
the i^{th} TCI codepoint in the TCI field of the DCI is mapped to one of the activated DL/joint TCI states and two of the activated UL TCI states
the i^{th} TCI codepoint in the TCI field of the DCI is mapped to two of the activated DL/joint TCI states and one of the activated UL TCI states
the i^{th} TCI codepoint in the TCI field of the DCI is mapped to two of the activated DL/joint TCI states and two of the activated UL TCI states.

In some embodiments, a higher layer parameter (e.g., RRC parameter) may be configured to the UE that is used to indicate to the UE that the new MAC CE format needs to be used to indicate one of the above mapping possibilities. In one example, the parameter unifiedTCI-StateType-17 being set to ‘separate’, in combination with other higher layer parameters, may be used to indicate to the UE that the new MAC CE format needs to be used to indicate one of the above mapping possibilities. In another example, a new RRC parameter may be introduced for indicating this to the UE.

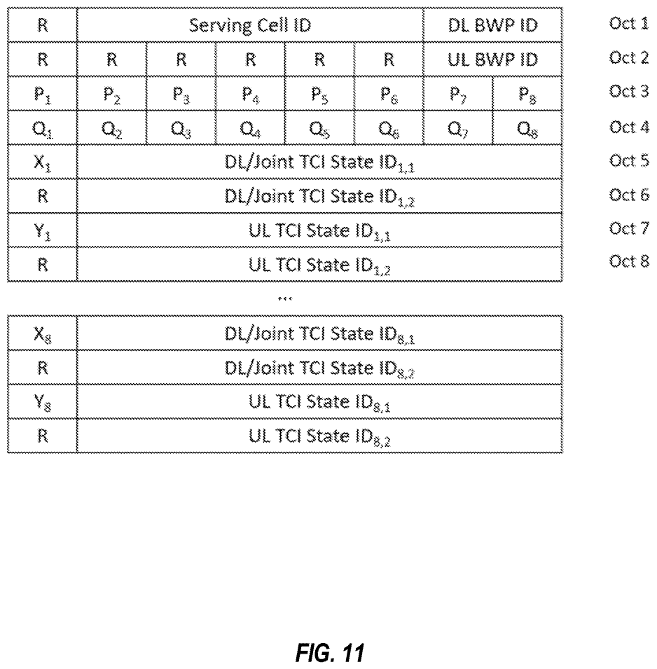

A new MAC CE format that allows the above TCI state mapping possibilities is proposed in FIG. 11.

The Pᵢ field in MAC CE of FIG. 11 can be interpreted as follows:
If the Pᵢ field is set to 1, it indicates that the i^{th} TCI codepoint in the TCI field of the DCI is mapped to a first activated DL/joint TCI state with ID ‘DL/Joint TCI State ID_{i,1}’.
If the Pᵢ field is set to 0, it indicates that the i^{th} TCI codepoint in the TCI field of the DCI is not mapped to any activated DL/joint TCI state. In other words, if the Pᵢ field is set to 0, then the octets indicated by IDs ‘DL/Joint TCI State ID_{i,1}’ and ‘DL/Joint TCI State ID_{i,2}’ are not present in the MAC CE.

The Xᵢ field present in the same octet as ‘DL/Joint TCI State ID_{i,1}’ in MAC CE of FIG. 11 can indicate if a second activated DL/Joint TCI state with ID ‘DL/Joint TCI State ID_{i,2}’ is mapped to the i^{th} TCI codepoint in the TCI field of the DCI.
If the Xᵢ field is set to 1, it indicates that the i^{th} TCI codepoint in the TCI field of the DCI is mapped to a second activated DL/joint TCI state with ID ‘DL/Joint TCI State ID_{i,2}’ in addition to the first activated DL/joint TCI state with ‘DL/Joint TCI State ID_{i,1}’.
If the Xᵢ field is set to 0, it indicates that the i^{th} TCI codepoint in the TCI field of the DCI is not mapped to a second activated DL/joint TCI state and is mapped to only one activated DL/joint TCI state with ‘DL/Joint TCI State ID_{i,1}’.

The Qᵢ field in MAC CE of FIG. 11 is interpreted as follows:
If the Qᵢ field is set to 1, it indicates that the i^{th} TCI codepoint in the TCI field of the DCI is mapped to a first activated UL TCI state with ID ‘UL TCI State ID_{i,1}’.
If the Qᵢ field is set to 0, it indicates that the i^{th} TCI codepoint in the TCI field of the DCI is not mapped to any activated UL TCI state. In other words, if the Qᵢ field is set to 0, then the octets indicated by IDs ‘UL TCI State ID_{i,1}’ and ‘UL TCI State ID_{i,2}’ are not present in the MAC CE.

The Yᵢ field present in the same octet as ‘UL TCI State ID_{i,1}’ in MAC CE of FIG. 11 indicates if a second activated UL TCI state with ID ‘UL TCI State ID_{i,2}’ is mapped to the i^{th} TCI codepoint in the TCI field of the DCI.
If the Yᵢ field is set to 1, it indicates that the i^{th} TCI codepoint in the TCI field of the DCI is mapped to a second activated UL TCI state with ID ‘UL TCI State ID_{i,2}’ in addition to the first activated UL TCI state with ‘UL TCI State ID_{i,1}’.
If the Yᵢ field is set to 0, it indicates that the i^{th} TCI codepoint in the TCI field of the DCI is not mapped to a second activated UL TCI state and is mapped to only one activated UL TCI state with ‘UL TCI State ID_{i,1}’.

In an alternative embodiment, the fields Pᵢ and Qᵢ may be merged into a single field where the following states can be indicated by different codepoints of this single joint field:
indicating that the i^{th} TCI codepoint in the TCI field of the DCI is mapped to at least one of the DL/joint TCI states and none of the UL TCI states.
indicating that the i^{th} TCI codepoint in the TCI field of the DCI is mapped to at least one of the UL TCI states and none of the DL/joint TCI states.
indicating that the i^{th} TCI codepoint in the TCI field of the DCI is mapped to at least one of the DL/joint TCI states and at least one of the UL TCI states.

As an alternative to embodiment 1, in embodiment 4, when a single list of DL/Joint TCI states is configured and at least one of the single DCI based multi-TRP schemes (either for downlink or uplink) is configured or enabled in a serving cell, then MAC CE of FIG. 11 is reused except that the Qᵢ fields are not present in the MAC CE. In this case, since a list of UL TCI states is not configured, the Qᵢ fields are unnecessary and are assumed not to be present in the MAC CE by the UE. Similarly, the Octets carrying the UL TCI state IDs in FIG. 11 are also assumed not to be present when a single list of DL/Joint TCI states is configured and at least one of the single DCI based multi-TRP schemes (either for downlink or uplink) is configured or enabled in a serving cell.

In one variant of this alternative embodiment, the reuse of the MAC CE of FIG. 11 (except for the Qᵢ fields) is based on one or more RRC parameters. For example, the parameter unifiedTCI-StateType-17 being set to ‘joint’, and UE being configured with Release 18 parameter(s) to enable UL or DL unified TCI state mTRP operation (or mode), indicates to the UE that it shall use the MAC CE of FIG. 11 (except Qᵢ fields) to activate a subset of DL/Joint TCI states.

In embodiment 5, when a list of DL/Joint TCI states and a list of UL TCI states are configured and at least one of the single DCI based multi-TRP schemes (either for downlink or uplink) is configured or enabled in a serving cell, then a new MAC CE format is introduced to indicate one of the following mapping possibilities for the i^{th} TCI field codepoint in the TCI field of a DCI:
the i^{th} TCI codepoint in the TCI field of the DCI is mapped to one of the activated DL/joint TCI states
the i^{th} TCI codepoint in the TCI field of the DCI is mapped to two of the activated DL/joint TCI states
the i^{th} TCI codepoint in the TCI field of the DCI is mapped to one of the activated UL TCI states
the i^{th} TCI codepoint in the TCI field of the DCI is mapped to two of the activated UL TCI states
the i^{th} TCI codepoint in the TCI field of the DCI is mapped to one of the activated DL/joint TCI states and one of the activated UL TCI states
the i^{th} TCI codepoint in the TCI field of the DCI is mapped to one of the activated DL/joint TCI states and two of the activated UL TCI states
the i^{th} TCI codepoint in the TCI field of the DCI is mapped to two of the activated DL/joint TCI states and one of the activated UL TCI states
the i^{th} TCI codepoint in the TCI field of the DCI is mapped to two of the activated DL/joint TCI states and two of the activated UL TCI states

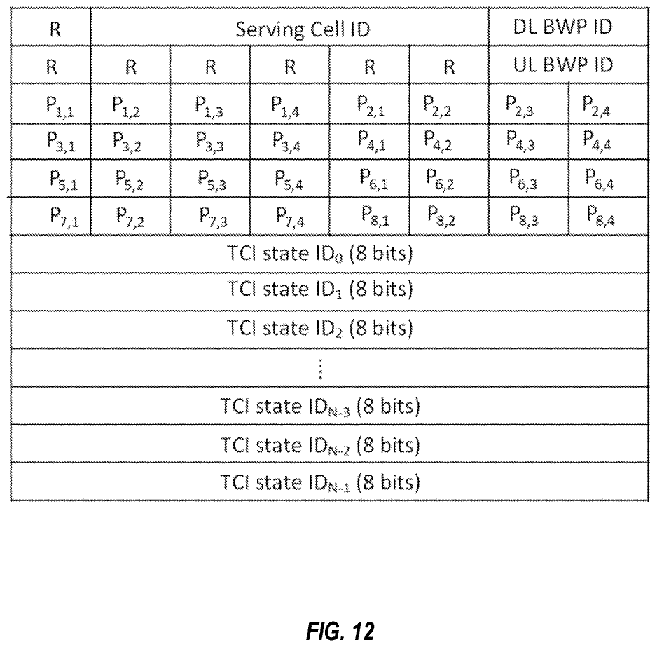

A new MAC CE format that allows the above TCI state mapping possibilities is proposed in FIG. 12. The field in the MAC CE depicted in FIG. 12 are interpreted as follows:

The P_{i,j} field in MAC CE of FIG. 12 is interpreted as follows:
P_{i,j} for j=1,2 indicates if DL/joint TCI states are mapped to the i^{th} TCI codepoint
P_{i,j} for j=3,4 indicates if UL TCI states are mapped to the i^{th} TCI codepoint

For example, if

$${P}_{1 , 1} = 1$$

$${P}_{1 , 2} = 0$$

$${P}_{1 , 3} = 0$$

$${P}_{1 , 4} = 1$$

It means that the first TCI codepoint in the TCI field of the DCI is mapped to one of the activated DL/joint TCI states and one of the activated UL TCI states. TCI state ID₀ in FIG. 12 will thus point to a DL/joint TCI state, and TCI state ID₁ in FIG. 12 will point to an UL TCI state.

In the previous embodiments, it is assumed that up to 8 TCI codepoints are supported. When more than 8 TCI codepoints are supported, in Embodiment 6, a different MAC CE format may be used to activate unified TCI states for multiple TRPs. In the new MAC CE format, for each TCI codepoint, the presence of one or more of the following TCI states associated to the TCI codepoint is indicated in the MAC CE, either explicitly or implicitly:
a first DL or joint DL/UL TCI state
a second DL or joint DL/UL TCI state
a first UL TCI state
a second UL TCI state

The first DL and UL TCI states are associated to a first TRP while the second DL and UL TCI states are associated to a second TRP.

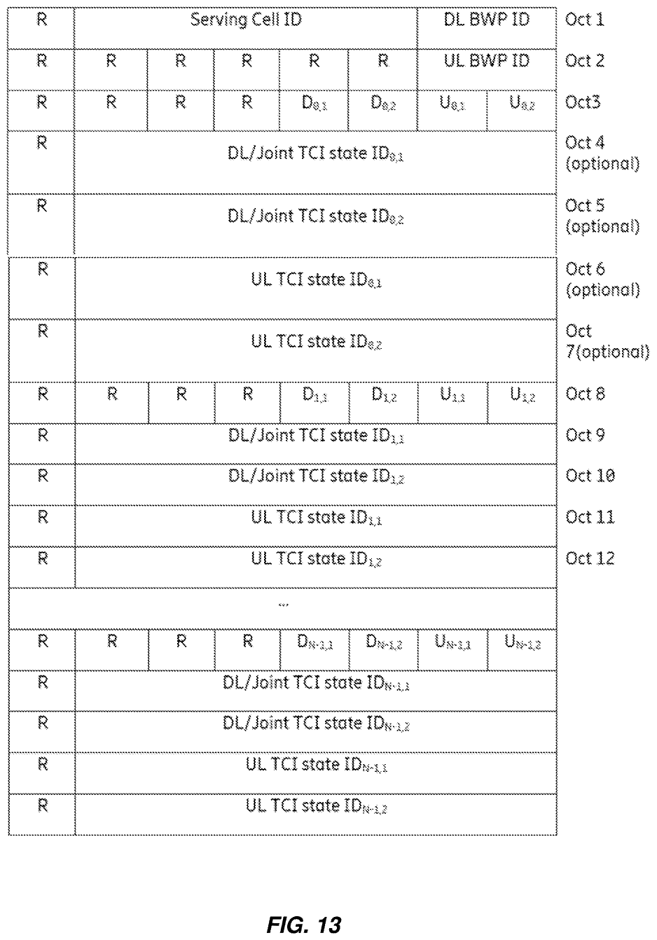

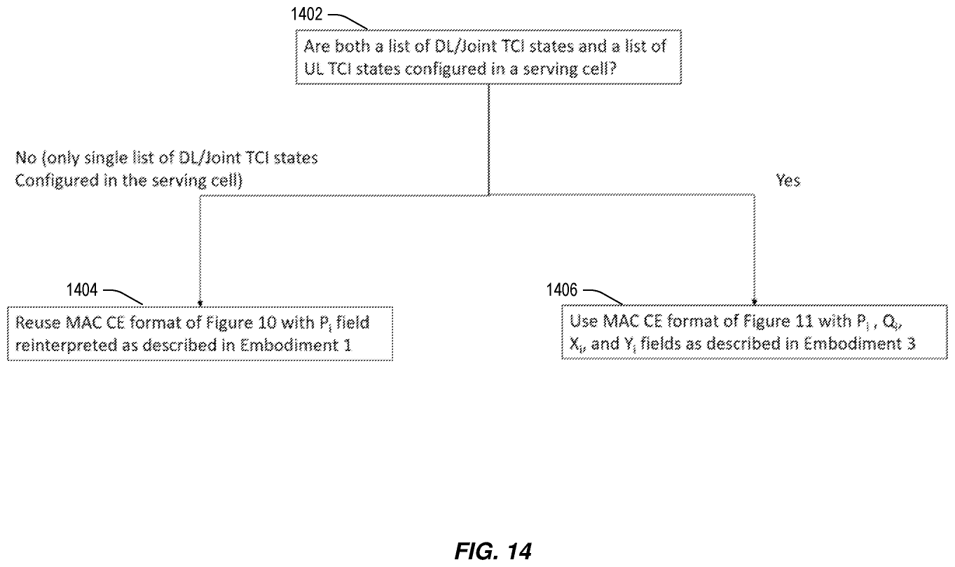

An example is shown in FIG. 13, where for TCI codepoint i, the presence of the first and second DL TCI states (i.e., DL/Joint TCI state ID_{i,1} and DL/Joint TCI state ID_{i,2}) are explicitly indicated by bits D_{i,1} and D_{i,2}, respectively, and the presence of the first and second UL TCI states (i.e., UL TCI state ID_{i,1} and UL TCI state ID_{i,2}) are explicitly indicated by bits U_{i,1} and U_{i,2}, respectively. A TCI state is present if the corresponding bit is set to 1 and is absent if the corresponding bit is set to 0. For each TCI codepoint, at least one of the TCI states should be present. Note that the exact locations of the indication bits D_{i,1}, D_{i,2}, U_{i,1} and U_{i,2} may be different from the ones shown in FIG. 13. For example, the indication bits for two TCI codepoints may be allocated together in a same octet and the bits for all TCI codepoints may be located together in consecutive octets.

When joint DL/UL TCI states are configured, the first and the second UL TCI states are not present and thus, U_{i,1}=0 and U_{i,2}=0 for all TCI codepoints. Alternatively, a separate MAC CE can be defined for the case where joint DL/UL TCI states are configured, in which the bits, U_{i,1} and U_{i,2} are not present in the MAC CE. In the MAC CE of FIG. 13, the number of codepoints in the TCI field of DCI are given by N.

FIG. 14 is a flowchart showing which MAC CE format to use depending on the number of configured lists of TCI states. For example, at 1402, the UE that receives the RRC signaling can determine whether both a list of DL/joint TCI states and a list of UL TCI states are configured for a serving cell. If the answer is no, then at 1404, the UE reuses the MAC CE format of FIG. 10 with Pᵢ field reinterpreted as described in Embodiment 1. If the answer is yes, then at 1406, the UE uses the MAC CE format of FIG. 11 with Pᵢ, Qᵢ, Xᵢ, and Yᵢ fields as described in Embodiment 3.

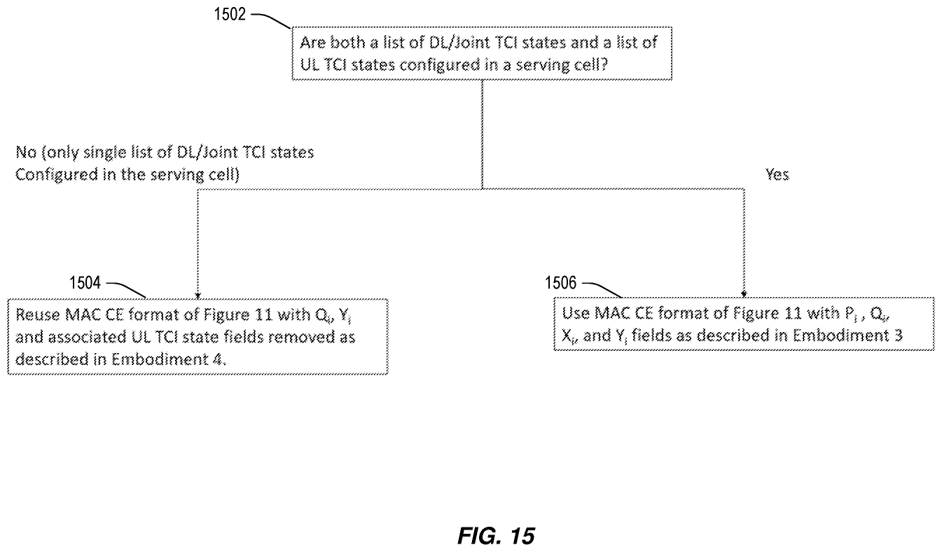

In FIG. 15, a flowchart is shown to determine which MAC CE format to use depending on the number of configured lists of TCI states. For example, at 1502, the UE that receives the RRC signaling can determine whether both a list of DL/joint TCI states and a list of UL TCI states are configured for a serving cell. If the answer is no and only a single list of DL/Joint TCI states are configured, then at 1504, the UE reuses the MAC CE format of FIG. 11 with Qᵢ and Yᵢ and associated UL TCI states fields removed as described in Embodiment 4. If the answer is yes, then at 1506, the UE uses the MAC CE format of FIG. 11 with Pᵢ, Qᵢ, Xᵢ, and Yᵢ fields as described in Embodiment 3.

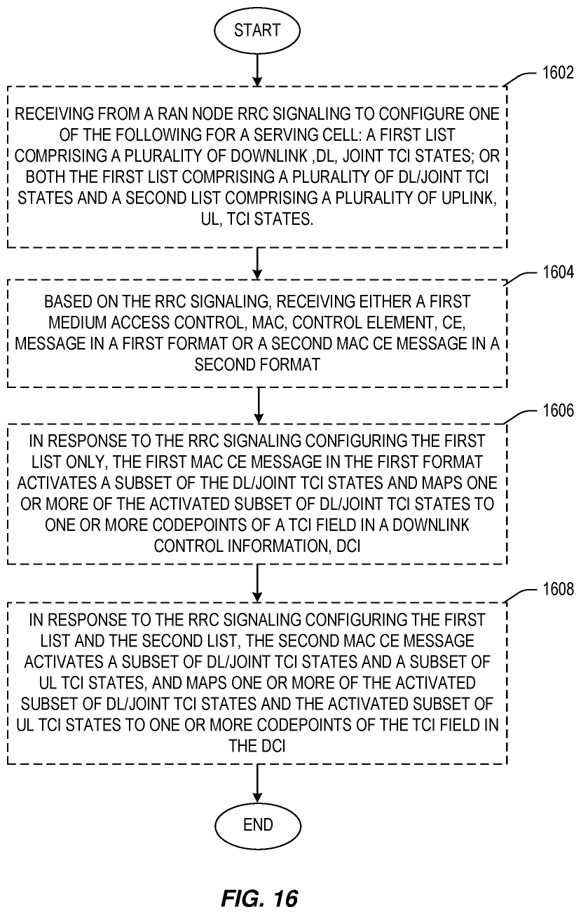

FIG. 16 is a flow chart of a method performed by a UE for facilitating unified TCI states for single TRP or multi-TRP schemes. The method optionally comprises of one or more of steps 1602-1608. The method begins at step 1602 which includes receiving from a RAN node RRC signaling to configure one of the following for a serving cell: a first list comprising a plurality of DL/joint TCI states or both the first list comprising a plurality of DL/joint TCI states and a second list comprising a plurality of uplink, UL, TCI states.

At step 1604, the method includes based on the RRC signaling, receiving either a first MAC CE message in a first format or a second MAC CE message in a second format.

At step 1606, the method optionally includes in response to the RRC signaling, configuring the first list only, the first MAC CE message in the first format activating a subset of the DL/joint TCI states and mapping one or more of the activated subset of DL/joint TCI states to one or more codepoints of a TCI field in a DCI.

At step 1608, the method optionally includes in response to the RRC signaling configuring the first list and the second list, the second MAC CE message activating (1608) a subset of DL/joint TCI states and a subset of UL TCI states, and mapping one or more of the activated subset of DL/joint TCI states and the activated subset of UL TCI states to one or more codepoints of the TCI field in the DCI.

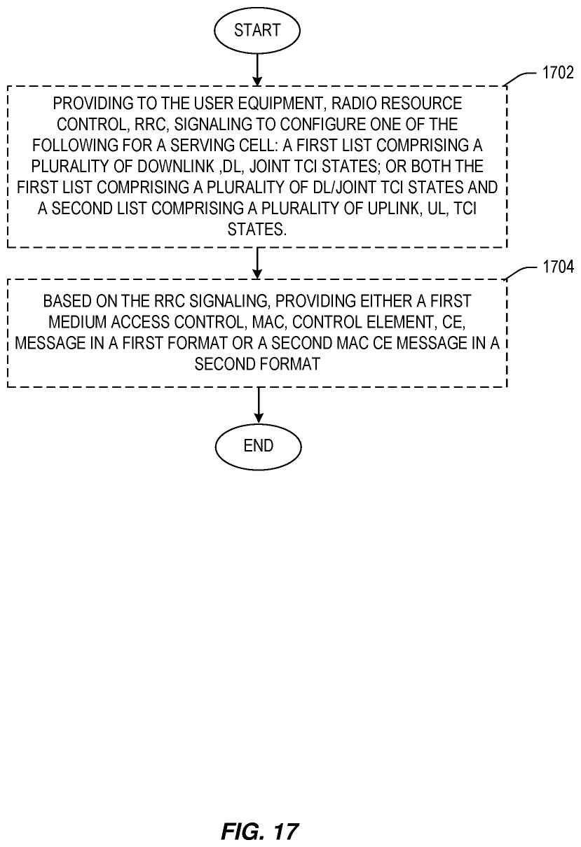

FIG. 17 is a flow chart of a method performed by a RAN node for facilitating unified TCI states for single TRP or multi-TRP schemes. The method optionally comprises of one or more of steps 1702-1704. At 1702 the method includes providing to the user equipment RRC signaling to configure one of the following for a serving cell: a first list comprising a plurality of DL joint TCI states or both the first list comprising a plurality of DL/joint TCI states and a second list comprising a plurality of uplink, UL, TCI states.

At 1704, the method includes based on the RRC signaling, providing either a first MAC CE message in a first format or a second MAC CE message in a second format.

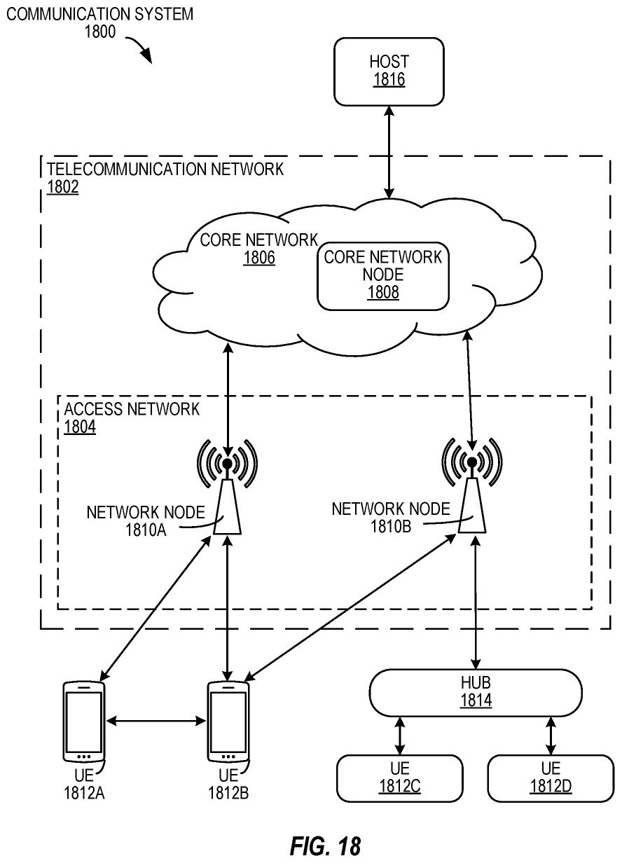

FIG. 18 shows an example of a communication system 1800 in accordance with some embodiments.

In the example, the communication system 1800 includes a telecommunication network 1802 that includes an access network 1804, such as a Radio Access Network (RAN), and a core network 1806, which includes one or more core network nodes 1808. The access network 1804 includes one or more access network nodes, such as network nodes 1810A and 1810B (one or more of which may be generally referred to as RAN nodes 1810), or any other similar Third Generation Partnership Project (3GPP) access node or non-3GPP Access Point (AP). The network nodes 1810 facilitate direct or indirect connection of User Equipment (UE), such as by connecting UEs 1812A, 1812B, 1812C, and 1812D (one or more of which may be generally referred to as UEs 1812) to the core network 1806 over one or more wireless connections. The RAN node 1810 can perform the method described in FIG. 17, and the UE 1812 can perform the method described in FIG. 16, and in the embodiments described in the disclosure.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system 1800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1802 is a cellular network that implements 3GPP standardized features. Accordingly, the telecommunication network 1802 may support network slicing to provide different logical networks to different devices that are connected to the telecommunication network 1802. For example, the telecommunication network 1802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1814 communicates with the access network 1804 to facilitate indirect communication between one or more UEs (e.g., UE 1812C and/or 1812D) and network nodes (e.g., network node 1810B). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a Virtual Reality (VR) headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810B. The hub 1814 may also allow for a different communication scheme and/or schedule between the hub 1814 and UEs (e.g., UE 1812C and/or 1812D), and between the hub 1814 and the core network 1806. In other examples, the hub 1814 is connected to the core network 1806 and/or one or more UEs via a wired connection. Moreover, the hub 1814 may be configured to connect to a Machine-to-Machine (M2M) service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810B. In other embodiments, the hub 1814 may be a non-dedicated hub—that is, a device which is capable of operating to route communications between the UEs and the network node 1810B, but which is additionally capable of operating as a communication start and/or end point for certain data channels.

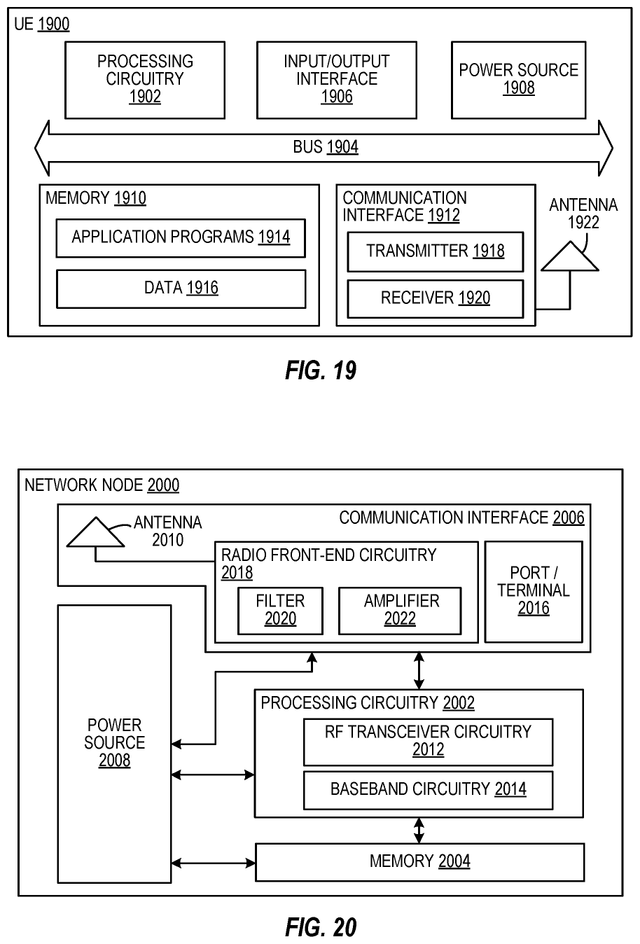

FIG. 19 shows a UE 1900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1902 may include multiple Central Processing Units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging the power source 1908. Power circuitry may perform any formatting, converting, or other modification to the power from the power source 1908 to make the power suitable for the respective components of the UE 1900 to which power is supplied.

The memory 1910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1910 may allow the UE 1900 to access instructions, application programs, and the like stored on transitory or non-transitory memory media, to off-load data, or to upload data. An article of manufacture, such as one utilizing a communication system, may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., the antenna 1922) and may share circuit components, software, or firmware, or alternatively be implemented separately.

In the illustrated embodiment, communication functions of the communication interface 1912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 20 shows a network node 2000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes processing circuitry 2002, memory 2004, a communication interface 2006, and a power source 2008. The network node 2000 may be composed of multiple physically separate components (e.g., a Node B component and an RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 2000 may be configured to support multiple RATs. In such embodiments, some components may be duplicated (e.g., separate memory 2004 for different RATs) and some components may be reused (e.g., an antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 2000.

The processing circuitry 2002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 2000 components, such as the memory 2004, to provide network node 2000 functionality.

In some embodiments, the processing circuitry 2002 includes a System on a Chip (SOC). In some embodiments, the processing circuitry 2002 includes one or more of Radio Frequency (RF) transceiver circuitry 2012 and baseband processing circuitry 2014. In some embodiments, the RF transceiver circuitry 2012 and the baseband processing circuitry 2014 may be on separate chips (or sets of chips), boards, or units, such as radio units and digital units. In alternative embodiments, part or all of the RF transceiver circuitry 2012 and the baseband processing circuitry 2014 may be on the same chip or set of chips, boards, or units.

The memory 2004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and the memory 2004 are integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. The radio front-end circuitry 2018 comprises filters 2020 and amplifiers 2022. The radio front-end circuitry 2018 may be connected to the antenna 2010 and the processing circuitry 2002. The radio front-end circuitry 2018 may be configured to condition signals communicated between the antenna 2010 and the processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of the filters 2020 and/or the amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface 2006 may comprise different components and/or different combinations of components.

In certain alternative embodiments, the network node 2000 does not include separate radio front-end circuitry 2018; instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes the one or more ports or terminals 2016, the radio front-end circuitry 2018, and the RF transceiver circuitry 2012 as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, the communication interface 2006, and/or the processing circuitry 2002 may be configured to perform any receiving operations and/or certain obtaining operations described herein as being performed by the network node 2000. Any information, data, and/or signals may be received from a UE, another network node, and/or any other network equipment. Similarly, the antenna 2010, the communication interface 2006, and/or the processing circuitry 2002 may be configured to perform any transmitting operations described herein as being performed by the network node 2000. Any information, data, and/or signals may be transmitted to a UE, another network node, and/or any other network equipment.

The power source 2008 provides power to the various components of the network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid or an electricity outlet) via input circuitry or an interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

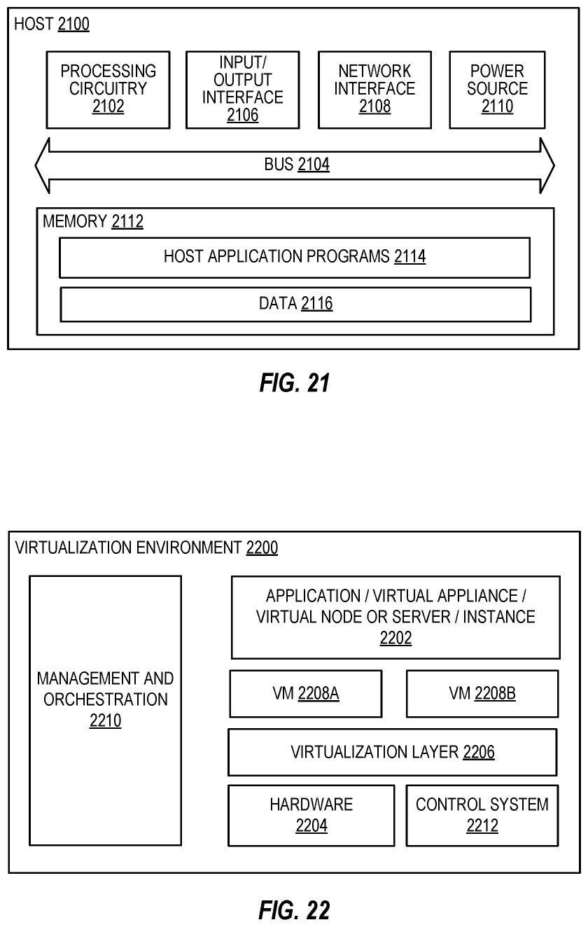

FIG. 21 is a block diagram of a host 2100, which may be an embodiment of the host 1816 of FIG. 18, in accordance with various aspects described herein. As used herein, the host 2100 may be or comprise various combinations of hardware and/or software including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and memory 2112. Other components may be included in other embodiments. Features of these components may be substantially similar to those described with respect to the devices of previous figures, such as FIGS. 19 and 20, such that the descriptions thereof are generally applicable to the corresponding components of the host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems).

The host application programs 2114 may also provide for user authentication and licensing checks and may periodically report health, routes, and content availability to a central node, such as a device in or on the edge of a core network. Accordingly, the host 2100 may select and/or indicate a different host for Over-The-Top (OTT) services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2200 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or VM Monitors (VMMs)), provide VMs 2208A and 2208B (one or more of which may be generally referred to as VMs 2208), and/or perform any of the functions, features, and/or benefits described in relation with some embodiments described herein. The virtualization layer 2206 may present a virtual operating platform that appears like networking hardware to the VMs 2208.

The VMs 2208 comprise virtual processing, virtual memory, virtual networking, or interface and virtual storage, and may be run by a corresponding virtualization layer 2206. Different embodiments of the instance of a virtual appliance 2202 may be implemented on one or more of the VMs 2208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2208 may be a software implementation of a physical machine that runs programs as if they were executing on a physical, non-virtualized machine. Each of the VMs 2208, and that part of the hardware 2204 that executes that VM, be it hardware dedicated to that VM and/or hardware shared by that VM with others of the VMs 2208, forms separate virtual network elements. Still in the context of NFV, a virtual network function is responsible for handling specific network functions that run in one or more VMs 2208 on top of the hardware 2204 and corresponds to the application 2202.

The hardware 2204 may be implemented in a standalone network node with generic or specific components. The hardware 2204 may implement some functions via virtualization. Alternatively, the hardware 2204 may be part of a larger cluster of hardware (e.g., such as in a data center or CPE) where many hardware nodes work together and are managed via management and orchestration 2210, which, among others, oversees lifecycle management of the applications 2202. In some embodiments, the hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2212 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:
Embodiment 1: A method performed by a user equipment (1812) for facilitating unified Transmission Configuration Indicator, TCI, states for single or multi Transmission Reception Point, TRP, use, the method comprising one or more of:
receiving (1602) from a Radio Access Network, RAN, node (1810), Radio Resource Control, RRC, signaling to configure one of the following for a serving cell:
   i. a first list comprising a plurality of downlink, DL, joint TCI states; or
   ii. both the first list comprising a plurality of DL/joint TCI states and a second list comprising a plurality of uplink, UL, TCI states;
based on the RRC signaling, receiving (1604) either a first Medium Access Control, MAC, Control Element, CE, message in a first format or a second MAC CE message in a second format, wherein:
   optionally, in response to the RRC signaling configuring the first list only, the first MAC CE message in the first format activating (1606) a subset of the DL/joint TCI states and mapping one or more of the activated subset of DL/joint TCI states to one or more codepoints of a TCI field in a Downlink Control Information, DCI; and/or
   optionally, in response to the RRC signaling configuring the first list and the second list, the second MAC CE message activating (1608) a subset of DL/joint TCI states and a subset of UL TCI states, and mapping one or more of the activated subset of DL/joint TCI states and the activated subset of UL TCI states to one or more codepoints of the TCI field in the DCI.
Embodiment 2: The method of embodiment 1, wherein the RRC signaling comprises an explicit indication to use the first MAC CE message with the first format or the second MAC CE message with the second format.
Embodiment 3: The method of any of embodiments 1 to 2, wherein in response to a single DCI-based multi-TRP configuration being used in the serving cell:
a first field corresponding to the i^{th} TCI codepoint in the first MAC CE message indicates whether the i^{th} TCI codepoint is mapped to one DL/joint TCI states of the plurality of DL/joint TCI states or two of the DL/joint TCI states of the plurality of DL/joint TCI states.
Embodiment 4: The method of any of embodiments 1 to 2, wherein in response to a single DCI-based multi-TRP configuration being used in the serving cell:
a first field corresponding to the i^{th} TCI codepoint in the second MAC CE message indicates whether the i^{th} TCI codepoint is mapped to at least one of the plurality of DL/joint TCI states or none of the plurality of DL/joint TCI states.
Embodiment 5: The method of embodiment 4, wherein in response to the first field indicating that the i^{th} TCI codepoint is mapped to at least one of the plurality of DL/joint TCI states the second MAC CE message further comprises a second field corresponding to the i^{th} TCI codepoint in the second MAC CE message that indicates whether the i^{th} TCI codepoint is mapped to only one DL/joint TCI state of the plurality of DL/joint TCI states or two DL/joint TCI states of the plurality of DL/joint TCI states.
Embodiment 6: The method of any of embodiments 4 to 5, wherein a presence of an identifier field corresponding to the second of the plurality of DL/joint TCI states being mapped to the i^{th} TCI codepoint is conditioned on one or both of the following:
the first field indicating that the i^{th} TCI codepoint is mapped to at least one of the plurality of DL/joint TCI states; and
the second field indicating that the i^{th} TCI codepoint is mapped to two of the plurality of DL/joint TCI states.
Embodiment 7: The method of any of embodiments 1 to 2, wherein in response to a single DCI-based multi-TRP configuration being used in the serving cell:
a third field corresponding to the i^{th} TCI codepoint in the second MAC CE message indicates whether the i^{th} TCI codepoint is mapped to at least one UL TCI state of the plurality of UL TCI states or none of the plurality of UL TCI states.
Embodiment 8: The method of embodiment 7, wherein in response to the third field indicating that the i^{th} TCI codepoint in the second MAC CE message is mapped to at least one UL TCI state of the plurality of UL TCI states, the second MAC CE message further comprises a fourth field corresponding to the i^{th} TCI codepoint that indicates whether the i^{th} TCI codepoint is mapped to only one UL TCI state of the plurality of UL TCI states or two UL TCI states of the plurality of UL TCI states.
Embodiment 9: The method of any of embodiments 7 to 8, wherein the presence of an identifier field corresponding to the second of the plurality of UL TCI states being mapped to the i^{th} TCI codepoint is conditioned on one or both of the following:
the third field indicating that the i^{th} TCI codepoint is mapped to at least one UL TCI state of the plurality of UL TCI states; and
the fourth field indicating that the i^{th} TCI codepoint is mapped to two UL TCI states of the plurality of UL TCI states.
Embodiment 10: The method of embodiment 1, wherein the first MAC CE message and the second MAC CE message comprise a field that indicates whether the first MAC CE message or the second MAC CE message is to be used for single TRP or multi-TRP operation.
Embodiment 11: The method of embodiment 1, wherein in response to the RRC signaling configuring only the first list comprising the plurality of DL joint TCI states, the first MAC CE message omits fields associated with UL TCI states.
Embodiment 12: The method of embodiment 11, wherein the RRC signaling indicates that the first MAC CE message omits fields associated with UL TCI states based on an RRC parameter.
Embodiment 13: The method of embodiment 1, wherein for the first MAC CE message and the second MAC CE message for every i^{th} codepoint, a presence of one or more of the following TCI states is indicated:
a first DL or joint DL/UL TCI state;
a second DL or joint DL·UL TCI state;
a first UL TCI state; and
a second UL TCI state.
Embodiment 14: A user equipment, UE, (1812) for facilitating unified Transmission Configuration Indicator, TCI, states for single or multi Transmission Reception Point, TRP, use, the UE comprising:
processing circuitry configured to perform one or more of:
   receive (1602) from a Radio Access Network, RAN, node (1810), Radio Resource Control, RRC, signaling to configure one of the following for a serving cell:
   i. a first list comprising a plurality of downlink, DL, joint TCI states; or
   ii. both the first list comprising a plurality of DL/joint TCI states and a second list comprising a plurality of uplink, UL, TCI states;
   based on the RRC signaling, receive (1604) either a first Medium Access Control, MAC, Control Element, CE, message in a first format or a second MAC CE message in a second format, wherein:
   optionally, in response to the RRC signaling configuring the first list only, the first MAC CE message in the first format activate (1606) a subset of the DL/joint TCI states and map one or more of the activated subset of DL/joint TCI states to one or more codepoints of a TCI field in a Downlink Control Information, DCI; and
   optionally, in response to the RRC signaling configuring the first list and the second list, the second MAC CE message activate (1608) a subset of DL/joint TCI states and a subset of UL TCI states, and map one or more of the activated subset of DL/joint TCI states and the activated subset of UL TCI states to one or more codepoints of the TCI field in the DCI.
Embodiment 15: The UE (1812) of embodiment 14, wherein the processing circuitry is further configured to perform any of the steps of embodiments 2-13
Embodiment 16: A method performed by a Radio Access Network, RAN, node (1810) for facilitating unified Transmission Configuration Indicator, TCI, states for single or multi Transmission Reception Point, TRP, use, the method comprising one or more of:
providing (1702) to the user equipment (1812), Radio Resource Control, RRC, signaling to configure one of the following for a serving cell:
   i. a first list comprising a plurality of downlink, DL, joint TCI states; or
   ii. both the first list comprising a plurality of DL/joint TCI states and a second list comprising a plurality of uplink, UL, TCI states;
based on the RRC signaling, providing (1704) either a first Medium Access Control, MAC, Control Element, CE, message in a first format or a second MAC CE message in a second format.
Embodiment 17: The method of embodiment 16, wherein the RRC signaling comprises an explicit indication to use the first MAC CE message with the first format or the second MAC CE message with the second format.
Embodiment 18: The method of any of embodiments 16 to 17, wherein in response to a single Downlink Control Information, DCI, based multi-TRP configuration being used in the serving cell:
a first field corresponding to the i^{th} TCI codepoint in the first MAC CE message indicates whether the i^{th} TCI codepoint is mapped to one DL/joint TCI states of the plurality of DL/joint TCI states or two of the DL/joint TCI states of the plurality of DL/joint TCI states.
Embodiment 19: The method of any of embodiments 16 to 17, wherein in response to a single DCI-based multi-TRP configuration being used in the serving cell:
a first field corresponding to the i^{th} TCI codepoint in the second MAC CE message indicates whether the i^{th} TCI codepoint is mapped to at least one of the plurality of DL/joint TCI states or none of the plurality of DL/joint TCI states.
Embodiment 20: The method of embodiment 19, wherein in response to the first field indicating that the i^{th} TCI codepoint is mapped to at least one of the plurality of DL/joint TCI states the second MAC CE message further comprises a second field corresponding to the i^{th} TCI codepoint in the second MAC CE message that indicates whether the i^{th} TCI codepoint is mapped to only one DL/joint TCI state of the plurality of DL/joint TCI states or two DL/joint TCI states of the plurality of DL/joint TCI states.
Embodiment 21: The method of any of embodiments 19 to 20, wherein a presence of an identifier field corresponding to the second of the plurality of DL/joint TCI states being mapped to the i^{th} TCI codepoint is conditioned on one or both of the following:
the first field indicating that the i^{th} TCI codepoint is mapped to at least one of the plurality of DL/joint TCI states; and
the second field indicating that the i^{th} TCI codepoint is mapped to two of the plurality of DL/joint TCI states.
Embodiment 22: The method of any of embodiments 16 to 17, wherein in response to a single DCI-based multi-TRP configuration being used in the serving cell:
a third field corresponding to the i^{th} TCI codepoint in the second MAC CE message indicates whether the i^{th} TCI codepoint is mapped to at least one UL TCI state of the plurality of UL TCI states or none of the plurality of UL TCI states.
Embodiment 23: The method of embodiment 22, wherein in response to the third field indicating that the i^{th} TCI codepoint in the second MAC CE message is mapped to at least one UL TCI state of the plurality of UL TCI states, the second MAC CE message further comprises a fourth field corresponding to the i^{th} TCI codepoint that indicates whether the i^{th} TCI codepoint is mapped to only one UL TCI state of the plurality of UL TCI states or two UL TCI states of the plurality of UL TCI states.
Embodiment 24: The method of any of embodiments 22 to 23, wherein the presence of an identifier field corresponding to the second of the plurality of UL TCI states being mapped to the i^{th} TCI codepoint is conditioned on one or both of the following:
the third field indicating that the i^{th} TCI codepoint is mapped to at least one UL TCI state of the plurality of UL TCI states; and
the fourth field indicating that the i^{th} TCI codepoint is mapped to two UL TCI states of the plurality of UL TCI states.
Embodiment 25: The method of embodiment 16, wherein the first MAC CE message and the second MAC CE message comprise a field that indicates whether the first MAC CE message or the second MAC CE message is to be used for single TRP or multi-TRP operation.
Embodiment 26: The method of embodiment 16, wherein in response to the RRC signaling configuring only the first list comprising the plurality of DL joint TCI states, the first MAC CE message omits fields associated with UL TCI states.
Embodiment 27: The method of embodiment 26, wherein the RRC signaling indicates that the first MAC CE message omits fields associated with UL TCI states based on an RRC parameter.
Embodiment 28: The method of embodiment 16, wherein for the first MAC CE message and the second MAC CE message for every i^{th} codepoint, a presence of one or more of the following TCI states is indicated:
a first DL or joint DL/UL TCI state;
a second DL or joint DL·UL TCI state;
a first UL TCI state; and
a second UL TCI state.
Embodiment 29: A Radio Access Network, RAN, node (1810) for facilitating unified Transmission Configuration Indicator, TCI, states for single or multi Transmission Reception Point, TRP, use, the UE comprising:
processing circuitry configured to perform one or more of the following:
   provide (1702) to the user equipment (1812), Radio Resource Control, RRC, signaling to configure one of the following for a serving cell:
   i. a first list comprising a plurality of downlink, DL, joint TCI states; or
   ii. both the first list comprising a plurality of DL/joint TCI states and a second list comprising a plurality of uplink, UL, TCI states;
based on the RRC signaling, provide (1704) either a first Medium Access Control, MAC, Control Element, CE, message in a first format or a second MAC CE message in a second format.
Embodiment 30: The RAN node (1810) of embodiment 29, wherein the processing circuitry is further configured to perform any of the steps of embodiments 17-28.

Those skilled in the art will recognize improvements and modifications to the embodiments of the present disclosure. All such improvements and modifications are considered within the scope of the concepts disclosed herein.

1. A method performed by a user equipment (UE) for facilitating unified Transmission Configuration Indicator (TCI) states for multi Transmission Reception Point (TRP) use, the method comprising:
receiving from a Radio Access Network (RAN) node, signaling for a single Downlink Control Information (DCD) multi-TRP scheme for a serving cell, wherein the signaling comprises a Medium Access Control (MAC) Control Element (CE) message that comprises:
a first field corresponding to the i^{th} TCI codepoint in the MAC CE message indicating whether the i^{th} TCI codepoint is mapped to at least one of a plurality of downlink (DL) joint TCI states; and
a second field corresponding to the i^{th} TCI codepoint in the MAC CE message indicating whether or not the i^{th} TCI codepoint is mapped to a second DL/joint TCI state;
activating a subset of DL/joint TCI states based on the MAC CE message and mapping one or more of the subset of DL/joint TCI states to one or more codepoints of the TCI field in the DCI.

2. The method of claim 1, wherein a presence of the second field is conditioned on;
the first field indicating that the i^{th} TCI codepoint is mapped to at least one of the plurality of DL/joint TCI states.

3. The method of claim 1, wherein a presence of an identifier field corresponding to the second of the plurality of DL/joint TCI states being mapped to the i^{th} TCI codepoint is conditioned on one or both of the following:
the first field indicating that the i^{th} TCI codepoint is mapped to at least one of the plurality of DL/joint TCI states; and
the second field indicating that the i^{th} TCI codepoint is mapped to two of the plurality of DL/joint TCI states.

4. The method of claim 1, wherein the MAC CE message further comprises:
a third field corresponding to the i^{th} TCI codepoint in the MAC CE message indicates whether the i^{th} TCI codepoint is mapped to at least one uplink (UL) TCI state of a plurality of UL TCI states or none of the plurality of UL TCI states.

5. The method of claim 4, wherein the MAC CE message further comprises:
a fourth field corresponding to the i^{th} TCI codepoint that indicates whether the i^{th} TCI codepoint is mapped to only one UL TCI state of the plurality of UL TCI states or two UL TCI states of the plurality of UL TCI states.

6. The method of claim 5, wherein a presence of the fourth field is conditioned on the third field indicating that the i^{th} TCI codepoint in the MAC CE message is mapped to at least one UL TCI state of the plurality of UL TCI states.

7. The method of claim 1, wherein in the MAC CE message, for every i^{th} codepoint, a presence of one or more of the following TCI states is indicated:
a first DL or joint DL/UL TCI state;
a second DL or joint DL/UL TCI state;
a first UL TCI state; and
a second UL TCI state.

8. The method of claim 1, wherein a Radio Resource Control (RRC) configuration indicates that the MAC CE message omits fields associated with UL TCI states based on an RRC parameter.

9. A user equipment (UE) for facilitating unified Transmission Configuration Indicator (TCD) states for single or multi Transmission Reception Point (TRP) use, the UE comprising:
processing circuitry configured to perform one or more of:
receive from a Radio Access Network (RAN) node, signaling to for a single Downlink Control Information (DCI) multi-TRP scheme for a serving cell, wherein the signaling comprises a Medium Access Control (MAC) Control Element (CE) message that comprises:
a first field corresponding to the i^{th} TCI codepoint in the MAC CE indicating whether the i^{th} TCI codepoint is mapped to at least one of a plurality of downlink (DL) joint TCI states; and
a second field corresponding to the i^{th} TCI codepoint in the MAC CE indicating whether or not the i^{th} TCI codepoint is mapped to a second DL/joint TCI state; and
activate a subset of DL/joint TCI states based on the MAC CE message and mapping one or more of the subset of DL/joint TCI states to one or more codepoints of the TCI field in the DCI.

10. (canceled)

11. A method performed by a user equipment (UE) for facilitating unified Transmission Configuration Indicator (TCI) states for multi Transmission Reception Point (TRP) use, the method comprising:
receiving from a Radio Access Network (RAN) node, signaling for a single Downlink Control Information (DCI) multi-TRP scheme for a serving cell, wherein the signaling comprises a Medium Access Control (MAC) Control Element (CE) message that comprises information indicating:
a first and/or second field indicating whether an i^{th} TCI codepoint is mapped to one or more downlink (DL) joint TCI state; and
a third and/or fourth field indicating whether the i^{th} TCI codepoint is mapped to one or more uplink (UL) TCI states; and
activating a subset of DL/joint TCI states and UL TCI states based on the MAC CE message and mapping one or more of the activated subset of DL/joint TCI states and UL TCI states to one or more codepoints of the TCI field in the DCI.

12. The method of claim 11, wherein in the MAC CE message, for every i^{th} codepoint, a presence of one or more of the following TCI states is indicated:
a first DL or joint DL/UL TCI state;
a second DL or joint DL/UL TCI state;
a first UL TCI state; and
a second UL TCI state.

13. The method of claim 11, wherein a Radio Resource Control (RRC) configuration indicates that the MAC CE message omits fields associated with UL TCI states based on an RRC parameter.

14. A user equipment (UE) for facilitating unified Transmission Configuration Indicator (TCI) states for single or multi Transmission Reception Point (TRP) use, the UE comprising:
processing circuitry configured to perform one or more of:
receiving from a Radio Access Network (RAN) node, signaling for a single Downlink Control Information (DCI) multi-TRP scheme for a serving cell, wherein the signaling comprises a Medium Access Control (MAC) Control Element (CE) message that comprises information indicating:
a first and/or second field indicating whether an i^{th} TCI codepoint is mapped to one or more downlink (DL) joint TCI state; and
a third and/or fourth field indicating whether the i^{th} TCI codepoint is mapped to one or more uplink (UL) TCI states; and
activating a subset of DL/joint TCI states and UL TCI states based on the MAC CE message and mapping one or more of the activated subset of DL/joint TCI states and UL TCI states to one or more codepoints of the TCI field in the DCI.

15. (canceled)

16. A method performed by a Radio Access Network (RAN) node for facilitating unified Transmission Configuration Indicator (TCI) states for single or multi Transmission Reception Point (TRP) use, the method comprising one or more of:
providing to a User Equipment device (UE), signaling for a single Downlink Control Information (DCI) multi-TRP scheme for a serving cell, wherein the signaling comprises a Medium Access Control (MAC) Control Element (CE) message that comprises:
a first field corresponding to the i^{th} TCI codepoint in the MAC CE message indicating whether the i^{th} TCI codepoint is mapped to at least one of a plurality of downlink (DL) joint TCI states; and
a second field corresponding to the i^{th} TCI codepoint in the MAC CE message indicating whether or not the i^{th} TCI codepoint is mapped to a second DL/joint TCI state.

17-19. (canceled)
